(19) United States
(12) Patent Application Publication
(10) Pub. No.: US 2017/0225956 A1
(43) Pub. Date: Aug. 10, 2017

(54) METHOD FOR COLLOIDAL PREPARATION OF A METAL CARBIDE, SAID METAL CARBIDE THUS PREPARED AND USES THEREOF

(71) Applicant: COMMISSARIAT A L'ENERGIE ATOMIQUE ET AUX ENERGIES ALTERNATIVES, Paris (FR)

(72) Inventors: Alvaro Saravia, AVIGNON (FR); Xavier Deschanels, LE PIN (FR); Stéphanie Szenknect, LAUDUN (FR); Meryl Brothier, AIX EN PROVENCE (FR); Olivier Fiquet, VENELLES (FR)

(21) Appl. No.: 15/501,964

(22) PCT Filed: Aug. 6, 2015
(86) PCT No.: PCT/EP2015/068198

§ 371 Date: Feb. 6, 2017

(30) Foreign Application Priority Data
Aug. 7, 2014 (FR) 14 57678

(51) Int. Cl. C01G 56/00

(52) U.S. Cl. CPC C01B 31/306; C01B 31/303; C01B 31/305; C01P 2004/03

(57) ABSTRACT

The present invention relates to a method for preparation of a powder comprising at least one carbide of at least one metal, comprising the steps consisting of: (a) preparing a solution comprising at least one organic gelling agent and at least one inorganic salt of at least one metal in a solvent; (b) modifying the pH of the solution prepared in step (a) in such a way as to precipitate said at least one metal and to obtain a colloidal suspension comprising nanoparticles of oxyhydroxides of said at least one metal; (c) removing the solvent from the colloidal suspension obtained in step (b) by which means a precursor of at least one carbide of at least one metal is obtained; and (d) subjecting the precursor obtained in step (c) to a thermal treatment in order to transform same into a powder comprising at least one carbide of at least one metal. The present invention also relates to the powder thus prepared and the various uses thereof.

### TECHNICAL FIELD

The present invention belongs to the technical field of metal carbides.

In fact, the present invention proposes a method for preparing and synthesising metal carbides by colloidal route making it possible to elaborate powders of metal carbides at low temperatures and having good sinterability.

More particularly, the novel synthesis route proposed in the present invention enables a significant gain in synthesis temperatures. This gain may be taken advantage of for the elaboration of dense materials at low temperature making it possible, in certain cases, such as, for example, in the case of mixed carbides such as mixed carbides of uranium and plutonium ((U,Pu)C), to reduce volatilisation of elements leading to a drift in composition and loss of material.

The present invention also relates to powders of metal carbides thus prepared and the use thereof for preparing dense materials of metal carbides and notably useful for the elaboration of carbide type nuclear fuels.

### PRIOR ART

In industry, much attention is being paid to the synthesis of metal carbides to produce technical ceramics. These compounds have a large number of applications on account of their physical/chemical properties and their remarkable characteristics. Metal carbide compounds have in general high hardness and melting temperature as well as good chemical stability. The properties of carbides enable their use in numerous application fields such as electronics, catalysis (transition metal carbide), protective coatings, anti-wear coatings, of great hardness (WC, TiC, etc.) and even as fuels or targets for the nuclear industry.

A very wide range of different possible routes for elaborating metal carbides exist. The following presentation is restricted to citing the most widely used routes and those that are the most similar to the method of the invention; notably synthesis by carboreduction and elaboration of powders by sol-gel route. The synthesis of metal carbides by carboreduction [1] implements the reaction of a mixture between a powdery metal oxide and carbon in the solid state (graphite or carbon black). This synthesis takes place at high temperature in conditions favourable to reduction and the corresponding equation is equation 1 hereafter:

MₓO_{y} (solid)+z C (solid)⇄MₓC_{z-y} (solid)+y CO (gas) (equation 1)

Equivalent reactions may be carried out from metal oxide of higher or lower valence and for the formation of dicarbide or sesquicarbides alone or as a mixture.

Imperfect mixing of the initial reagents can cause composition heterogeneities after synthesis, which can induce the formation of undesirable secondary phases in the final material [2]. Too great compactness of the powders, which limits the release of CO, can hinder the progress of the carboreduction reaction. A lowering of the carboreduction temperature is observed by introducing a step of grinding of the oxide precursors with graphite in order to make the mixture more intimate [3]. Grinding also leads to an increase in the reaction rate. Nevertheless, the grinding operation is relatively penalising from a radiological impact viewpoint in the case of the implementation of actinides (dissemination, risk of contamination).

Generally, products synthesised by this route contain residual oxygen contents. Carbides of actinides are very sensitive to oxidation, but the main source of oxygen content stems from incomplete reactivity of the oxides introduced initially in powder form. Increasing the carboreduction temperature makes it possible to favour the reaction towards the formation of carbide and to reduce the oxygen content in the final product. However, increasing the carboreduction temperature also favours the volatilisation of compounds. For mixed fuels (U,Pu)C, it is thus necessary to find an optimal temperature for the manufacturing method.

The atmosphere generally used during the synthesis of carbides by carboreduction is a rough vacuum. The use of a vacuum favours the formation of carbide by shifting the equilibria in the sense of the formation of gaseous species. The literature also describes the synthesis of carbide fuels under argon flow. The use of a high argon flow makes it possible to accelerate carboreduction [4]. Nevertheless, flushing with argon during the reaction is less efficient than the use of a vacuum, especially if bulk products are considered.

Since the 1970s, the concept of “soft chemistry”, made famous by Livage [5], has been developed to synthesise ceramics. Soft chemistry techniques (sol-gel, PDC for “polymer derived ceramics”), have then been used for the synthesis of carbides in order to reduce their synthesis temperature, to increase the homogeneity of the final product, to increase their specific surface, their adherence properties and thus to facilitate their shaping. In fine, these techniques make it possible to better control the synthesis of materials and to improve the characteristics of the final product obtained.

One of the innovations of soft chemistry is the passage from a mixture of reagents at the micrometric scale (mixture of powders) to a mixture at the nanometric scale, which generally makes it possible to reduce synthesis temperatures due to the proximity of the reagents, which favours inter-diffusion and an increase in the reaction surface [6-9]. Nevertheless, the literature does not describe any examples of elaboration of carbides of actinides.

The sol-gel method is used for the synthesis of a large number of carbides (Zr, Hf, Nb, Ta, etc.). The metal precursor is normally an oxide or an alkoxide which may be mixed with a source of molecular carbon (phenolic resin, glycerol, saccharose, polymer, etc.). The alkoxide gel is formed by polymerisation in the presence of acetic acid [10-12]. The carbon source is trapped in the gel. The thermal treatment is carried out in two steps, pyrolysis then carboreduction, in a continuous manner or not. The pyrolysis decomposes the organic molecules into amorphous carbon and gas (CO, CO₂ and H₂O) and generally causes the formation of metal oxide between 500° C. and 1100° C. The pyrolysis products are conventional carboreduction reagents. The difference with routes using carbon in the solid state is the intimacy of the oxide-carbon mixture, this nano-mixture obtained thus forms an excellent precursor for the synthesis of carbides. For example, zirconium carbide is obtained using Zr(OPr)₄ as metal source and glycerol or saccharose as carbon source [11].

The synthesis of ceramics by molecular chemistry has been studied, among others, by Corriu and Colombo [7,13]. Synthesis by molecular or supra-molecular chemistry is suited to the synthesis of silicon carbides. In fact, silicon can form covalent bonds with carbon thus enabling the synthesis of complex molecules. The precursor elements are then bound within a same molecule. The molecular precursors used are as varied as allowed by silicon chemistry. The precursors are then cross-linked to form the carbide. Mastering the chemistry of formation of the carbide enables excellent control of the composition and the structure of the final product, facilitating its later shaping.

To improve the homogeneity of carbides of actinides, so-called gelling methods have been developed. These methods make it possible for example to obtain a homogeneous solid solution for mixed oxide fuels (U,Pu)O₂. These methods have been modified for the synthesis of carbide and nitride fuels by introducing carbon during the preparation of the sol [14-16]. Several methods have thus been implemented by the SNAM [17] in Italy or at Oak Ridge [18-20]. Several variants of this method exist which are all inspired by the same basic principle [21]. These techniques have been used for the production of multilayer materials, notably TRISO nuclear fuel [16]. This so-called sol-gel route is dedicated to the production of oxides. The addition of carbon in powder form before the formation of the gel has also made it possible to obtain carbides.

Sugars represent a low cost carbon source which may be used for the synthesis of carbides. Once pyrolysed, sugars of overall formula Cₙ(H₂O)ₘ are excellent sources of amorphous carbon. They are interesting for the synthesis of carbides because these molecules are water soluble, non-polluting, rich in hydrogen bonds capable of creating weak interactions with oxides. Cerovick and Corriu [7,22] have noted a gain in temperature of around 100° C. between the carboreduction of a colloidal suspension of silica with carbon black (start of carboreduction close to 1400° C.) and of a colloidal suspension of silica with saccharose (start of carboreduction close to 1300° C.) [7,22]. This gain in carboreduction temperature is also notable for the formation of other types of carbides (Zr, Hf, Ce) [12]. For the synthesis of zirconium carbides, an aqueous solution of colloidal zirconium and saccharose is prepared, water is removed by lyophilisation. The powder obtained then undergoes a thermal treatment (pyrolysis-carboreduction) to form the carbide.

Other carbide synthesis routes have been recorded in the literature which use molecules very similar to sugar, notably sugar oligomers such as methyl cellulose [23,24]. Methyl cellulose has the advantage of forming a gel or a polymer film after drying. An aqueous suspension of nanoparticles of titanium oxide and methyl cellulose has been prepared by Gotoh et al [23] then dried to form a polymer film. After pyrolysis of the nanoparticles of titanium oxide mixed with methyl cellulose, these authors have observed a carboreduction temperature of 1300° C. instead of 1700° C.-2000° C. obtained during the pyrolysis of a TiO₂ powder/graphite type precursor.

Other types of protocols exist that bring into play titanium alkoxides with salicylic acid [25] or metal anions with citric acid [26] to form MₓO_{y}+C precursors (with M representing the metal element) for the carboreduction.

Finally, an original alternative route has been proposed by Adamczak et al [27]. The synthesis of metal carbides is carried out from metal salts in an organic medium. The carbon source used is an organic polymer (polystyrene, polyvinyl alcohol, polyimide). Adamczak et al [27] synthesise carbides of tantalum, niobium and tungsten by this method. A solution of metal salt (TaBr₅, NbBr₅, WCl₄, WCl₆) in ethanol is prepared, a second solution of the polymer is prepared in N-methyl pyrrolidone. The solutions are mixed together then thermally treated to remove the solvent. The precursor is then pyrolysed before undergoing carboreduction. The carboreduction temperature depends on the precursor used and varies between 900° C. and 1500° C. The temperature of start of carboreduction is 900° C. in the case of tantalum. This system would enable, if all the necessary precautions were taken, a synthesis of carbide in an oxygen-free medium.

To summarise, all known synthesis routes go through a step of carboreduction of a MₓO_{y}+C mixture elaborated from:
i) oxide and carbon powders (dry route);
ii) an oxide and carbon gel in the solid state;
iii) a sol-gel prepared from metal alkoxide, or
iv) an oxide and an organic polymer (sugar route, etc.).

A known difficulty during carboreduction is the degassing of carbon monoxide at the core of the pellets. It should be noted that many of the synthesis routes of the prior art described above do not make it possible to obtain an intimate mixture of metal oxide and carbon and that pelletizing is necessary in order to improve this contact. The inventors have set themselves the goal of proposing an alternative metal carbide synthesis route and simplified regarding the methods of the prior art (reduction in the number of steps and the temperature of the method), making it possible to prepare precursor powders of metal carbides, large specific surfaces and nanometric powders of metal carbides having optimised morphological and physical characteristics (specific surface, particle size, oxygen content).

### DESCRIPTION OF THE INVENTION

The present invention makes it possible to achieve the goal that the inventors set themselves and to resolve all or part of the technical problems encountered in the methods for preparation of metal carbides of the prior art.

The method according to the present invention makes it possible to easily synthesise precipitates of metal oxyhydroxides of MO_{(DO/2-n)}(OH)₂ₙ type, with 0≦n≦DO/2 (with DO=degree of oxidation of the metal element M), nanometric, homogenous and dispersed in a colloidal medium and to do so from a solution of a metal salt in the presence of an organic molecule. One of the originalities of this method is the triple role of the organic molecule implemented which makes it possible to:

i. create domains forming nanoreactors for the precipitation of nanoparticles of metal oxyhydroxides;

ii. stabilise the nanoparticles in order to limit their aggregation/agglomeration and thus their sedimentation; and

iii. input carbon after a thermal pyrolysis treatment, this organic molecule serving as molecular carbon source.

The method of the present invention thus proposes an innovative synthesis solution which makes it possible to obtain particles of small size, typically nanometric, dispersed in a carbon organic medium.

The precursors obtained by the method according to the present invention give intimate mixtures of metal oxide and carbon. Such mixtures make it possible to make optional or even to eliminate the step of shaping before carboreduction i.e. the pelletizing step. Thus, with such a precursor mixture, the carboreduction may be carried in a low density powder bed favouring the evacuation of gases.

In addition, within the scope of the present invention, the homogeneity of the precursors achieved at the nanometric scale makes it possible to reduce the synthesis temperature of the carbide and, indeed, the temperature necessary for the carboreduction notably under rough vacuum is decreased and the reaction kinetic is increased. This carboreduction may be carried out without addition of additional reagents. The control of the proportion of the MC, MₓC_{y} and MₓO_{y} phases, with M representing a metal, present in the final carbide may be ensured thanks to the increased reactivity of the novel precursor mixture.

Thus, the synthesis method according to the present invention makes it possible to obtain powders of metal carbides, having optimised physical and morphological characteristics (enhanced homogeneity, specific surface, particle size and reduction of the residual oxygen content), thus simplifying later steps of elaboration of high density ceramics by sintering and notably by making optional or even eliminating grinding steps. In fact, the improvement in the microstructural homogeneity of the metal carbide powders obtained, the control of their composition and the reduction in the final oxygen content in these powders are as many elements that improve the reactivity and the aptitude of the latter to sintering.

More particularly, the present invention relates to a method for preparation of a powder comprising at least one carbide of at least one metal comprising the steps consisting of:

a) preparing a solution comprising at least one organic gelling agent and at least one inorganic salt of at least one metal in a solvent;

b) modifying the pH of the solution prepared in step (a) in such a way as to precipitate nanoparticles of oxyhydroxides of said at least one metal in order to obtain a colloidal suspension;

c) removing the solvent from the colloidal suspension obtained in step (b) by which means a precursor of at least one carbide of at least one metal is obtained; and

d) subjecting the precursor obtained in step (c) to a thermal treatment in order to transform same into a powder comprising at least one carbide of at least one metal.

The method according to the present invention is remarkable in that said at least one organic gelling agent is the only carbon source used for the production of carbide.

Within the scope of the present invention, “carbide” means not just a monocarbide, a dicarbide, a sesquicarbide but also one of the mixtures thereof such as a mixture of monocarbide and dicarbide, a mixture of dicarbide and sesquicarbide, a mixture of monocarbide and sesquicarbide or instead a mixture of monocarbide, dicarbide and sesquicarbide.

As borne out previously, the two essential elements of the method according to the present invention are, on the one hand, the organic gelling agent and, on the other hand, the inorganic salt of at least one metal.

“Organic gelling agent” means, within the scope of the present invention, an organic compound, synthetic or natural, which forms a gel type matrix, in which the metal organic salt(s) and later the nanoparticles of metal oxyhydroxides are dispersed. Thus, this matrix enables the immobilisation of the metal or metals in order to prevent any segregation during later steps (c) and (d) and notably during the step of drying and pyrolysis. Such an organic gelling agent may also be designated as an organic thickening agent or instead an organic viscosity increasing agent.

Any organic gelling agent known to those skilled in the art may be used within the scope of the present invention. Advantageously, the organic gelling agent implemented within the scope of the invention is a macromolecule and notably a polymer and, more particularly, a polymer mainly constituted of atoms of carbon, oxygen and hydrogen, the other atoms such as, for example, atoms of sulphur, nitrogen, phosphorous, chlorine, bromine, fluorine or silicon represent at the most 10% and notably at the most 6% by number compared to the total number of polymer atoms.

The organic gelling agent implemented within the scope of the present invention may be soluble in polar solvents. Within the scope of the present invention “polar solvent” means a solvent selected from the group constituted of water, deionised water, distilled water, hydroxylated solvents such as methanol, ethanol and isopropanol, low molecular weight liquid glycols such as ethylene glycol, dimethyl sulfoxide (DMSO), dimethyl formamide (DMF), acetonitrile, acetone, tetrahydrofuran (THF) and one of the mixtures thereof. Advantageously, the organic gelling agent implemented within the scope of the present invention is water soluble.

Thus, the organic gelling agent implemented within the scope of the present invention may be a polyvinyl alcohol constituted of the repetition of the —CH₂—CH(OH)— monomer unit, a polymer of acrylic acid constituted of the repetition of the CH₂—CH(CO₂H)— monomer unit, a copolymer of acrylic acid-acrylamide comprising —CH₂—CH(CO₂H)— and —CH₂—CH(CONH₂)— monomer units, a polyvinyl pyrrolidone constituted of the repetition of the —CH₂—CH(NCOC₃H₆)— monomer unit.

In a variant, the organic gelling agent implemented within the scope of the invention is a polymer of polysaccharide type i.e. a polymer having a main chain or backbone constituted of the repetition of a monosaccharide, of several different monosaccharides, of a monosaccharide derivative such as glucuronic acid and/or of several different monosaccharide derivatives, optionally substituted, bound together by O-glycosidic bonds.

In this variant, the organic gelling agent implemented within the scope of the invention may be selected from the group consisting of cellulose derivatives such as esters of cellulose and ethers of cellulose, starch, pre-gelatinised starch, starch derivatives such as esters of starch and ethers of starch, natural extracts and natural gums. More particularly, it is selected from the group consisting of methyl cellulose, hydroxyl ethyl methyl cellulose, hydroxyl ethyl cellulose, carboxy methyl cellulose, hydroxyl propyl methyl cellulose, starch, methyl starch, hydroxyl ethyl methyl starch, hydroxyl ethyl starch, carboxy methyl starch, hydroxyl propyl methyl starch, carrageenan, alginate, furcellaran, agar-agar, glucomannan, galactomannan, xanthan gum, fenugreek gum, guar gum, tara gum, carob gum, cassia gum and gellan gum.

Apart from the organic gelling agent, the other essential element of the method according to the invention is the inorganic salt of at least one metal.

In fact, the present inventors have taken advantage of the property of metals i.e. metals of which the degree of oxidation is +II, +III, +IV, +V, +VI, enabling them to form insoluble oxides by hydrolysis. This hydrolysis takes place at a different pH depending on the metal considered, ranging, for example, from a relatively acid pH (case of plutonium or Pu(IV)) to basic pHs (case of uranium or U(IV)). Given their low solubility, this hydrolysis is followed by the precipitation in colloidal form of amorphous oxyhydroxides of MO_{(DO/2-n)}(OH)₂ₙ type, with 0≦n≦DO/2 (with DO=degree of oxidation of the metal element), changing over time and with temperature. The method according to the present invention implements this property and may thus be transposed to all metals having such a property.

Advantageously, the metal implemented is selected from the group constituted of metals belonging to the lanthanides, to the elements of group IV-B, to the elements of group IV-A and to actinides.

More particularly, the metal implemented within the scope of the present invention is selected from the group consisting of cerium, titanium, zirconium, hafnium, thorium, uranium, neptunium, plutonium, americium and curium.

Within the scope of the invention, the inorganic salt of at least one metal may be in the form of a halide, such as a fluoride, a chloride, a bromide or an iodide, of at least one metal or of a nitrate of at least one metal.

In the method according to the present invention, the preparation of a solution comprising at least one organic gelling agent and at least one inorganic salt of at least one metal in a solvent may comprise:
a step of preparation of a 1^{st} solution comprising at least one organic gelling agent designated solution (Sa),
a step of preparation of a 2^{nd} solution comprising at least one inorganic salt of at least one metal designated solution (Sb), then a step of mixing the solution (Sa) with the solution (Sb).

The step of preparation of the solution (Sa) consists in dissolving at least one organic gelling agent as defined previously in a suitable solvent, notably in a polar solvent as defined previously and, in particular, in water such as deionised water. This dissolution is carried out under agitation, for example, using an agitator, a magnetic stirrer bar, an ultrasound bath or a homogeniser. The temperature of the solvent implemented during the dissolution of the organic gelling agent implemented will depend on the nature of the solvent and of the gelling agent and the conditions necessary to obtain dissolution.

Depending on the organic gelling agent used, it may be necessary to apply an external stimulus so that it can form a gel type matrix. In other words, it may be necessary to apply an external stimulus so that the solution (Sa) in which the organic gelling agent has been dissolved goes from a state that can be described as liquid with, for example, a viscosity below 0.1 Pa·s, to a state that can truly be described as gelled, with a viscosity above 10 Pa·s and notably with a viscosity above 100 Pa·s. Depending on the organic gelling agent used, those skilled in the art will know how to select the most suitable external stimulus without inventive effort. This external stimulus is advantageously selected from the group consisting of the temperature of the solution (Sa), the pH of the solution (Sa), the mechanical agitation of the solution (Sa), the ultrasounds applied to the solution (Sa), a variation in the oxidation-reduction potential of the solution (Sa) and any combination thereof.

The step of preparation of the solution (Sb) consists in dissolving at least one inorganic salt of at least one metal as defined previously in a suitable solvent, notably in a polar solvent as defined previously, in particular, in water. The solution (Sb) may also be obtained by direct dissolution of the metal by a suitable acid such as, for example, hydrochloric acid. The solvent of the solution (Sa) and the solvent of the solution (Sb) may be identical or different on the sole condition in the latter case that they are miscible together. Thus, the solvent of the solution comprising at least one organic gelling agent and at least one inorganic salt of at least one metal is selected from polar solvents as defined previously and mixtures thereof.

It should be noted that the solvent of the solution (Sb) may, depending on the metal used, or the inorganic salt of at least one metal used, have to be acidified or made basic. This acidification or basification notably makes it possible to prevent the precipitation of the metal in the solution (Sb). Finally, the dissolution of the inorganic salt of at least one metal is carried out under agitation, for example, using an agitator, a magnetic stirrer bar, an ultrasound bath or a homogeniser.

Advantageously, the mixing of the solution (Sa) with the solution (Sb) consists in adding the solution (Sb) to the solution (Sa) in one go or in several stages or even drop by drop. This mixing is carried out under agitation, for example, using an agitator, a magnetic stirrer bar, an ultrasound bath or a homogeniser. It should be noted that the solution finally obtained during step (a) may be defined as a gelled solution or instead a sol in which the inorganic metal salt(s) are distributed in a homogeneous manner.

The quantity of organic gelling agent(s) and inorganic salt(s) of metal/metals in the solution prepared in step (a) depends, on the one hand, on the quantity of organic gelling agent required to obtain a gel able to later encapsulate and stabilise the nanoparticles of metal oxyhydroxides obtained following step (b) and, on the other hand, as a function of the ratio R_{C/M} (number of moles of carbon:number of moles of metal R_{C/M}=n_{C}/n_{M}) desired in the final metal carbide.

As regards the quantity of organic gelling agent required to obtain a suitable gel, those skilled in the art will know how to find this quantity without inventive effort, see in this respect the works shown in FIG. 6. As an illustrative and non-limiting example, when the organic gelling agent implemented is methyl cellulose, the solution prepared in step (a) comprises a quantity of methyl cellulose greater than or equal to 14 g·L⁻¹ of solution prepared in step (a) and advantageously of the order of 20 g·L⁻¹ (i.e. 20 g·L⁻¹±2 g·L⁻¹).

Step (b) of the method according to the present invention consists in modifying the pH of the solution comprising at least one organic gelling agent and at least one inorganic salt of at least one metal in a solvent in such a way as to hydrolyse the metal ion(s) contained in this solution.

This modification of the pH may be carried out by addition of a suitable quantity, depending on the case, i.e. depending on the metal ion(s), of a base such as sodium hydroxide, potassium hydroxide or ammonia or an acid such as hydrochloric acid, nitric acid, or sulfuric acid.

Depending on the pH of the aqueous solution containing the metal ion(s) and the pH at which the hydrolysis of the metal ion(s) has to be carried out, those skilled in the art will know what compound to use and in what quantity, without demonstrating any inventive effort. As an illustrative and non-limiting example, when the metal ion is uranium, the pH of the solution is taken, during step (b), to a value greater than or equal to 8.

The hydrolysis of the metal ion(s) leads to the precipitation of the latter in the form of oxyhydroxides. The gelled solution, the pH of which is modified enables the creation of reaction micro-domains and the formation of precipitates of very small size, perfectly dispersed within the suspension. This confinement makes it possible both to stabilise the suspension (absence of sedimentation) of the precursors of metal oxyhydroxides and to maintain homogeneity of the mixture at the nanometric scale. One can thus speak of a “colloidal suspension” or also a “colloidal dispersion”.

Advantageously, the precipitates obtained are in the form of nanostructured, submicronic particles:one can thus speak of “nanoparticles”. Thus, these particles have characteristic dimensions between 1 nm and 1000 nm, notably between 1 nm and 500 nm and, more precisely, between 1 nm and 100 nm.

The colloidal suspension obtained following step (b) of the method according to the present invention contains nanoparticles of oxyhydroxide of the metal/metals initially contained in the solution prepared in step (a) of the method. In addition, these metal compounds are generally amorphous and may optionally be in hydrated form.

Advantageously, step (b) of the method of the invention may be implemented under flow of an inert gas and notably under flow of argon, nitrogen or one of the mixtures thereof or ideally in a glove box and is so done notably to avoid the oxidation of the colloidal suspension obtained during this step.

Step (c) of the method according to the present invention consists in removing the solvent from the colloidal suspension obtained following step (b). In fact, during this step, the residual and interstitial solvents escape from the matrix formed, i.e. from the gel and evaporate, which causes contraction of the material. Apart from solvent, this step makes it possible to remove solvent(s) but also any other volatile elements present in the colloidal suspension such as the acid(s) or the base(s) used during step (b).

This removal is carried out by at least one technique selected from the group consisting of decantation, air drying, vacuum drying, microwave drying, high frequency drying, sublimation, lyophilisation or any combination thereof.

If step (c) of the method according to the invention involves drying, said drying is advantageously carried out at a controlled temperature and under atmosphere of dry inert gas (nitrogen, argon, air, etc.). The drying of the colloidal suspension may notably be carried out by arranging a cover permeable to gases and more particularly a porous film on the surface of the colloidal suspension then by placing the latter at room temperature (i.e. 21° C.±4° C.) or in a thermostatically controlled enclosure at a temperature between 40 and 130° C. and notably between 60 and 110° C. The drying may be carried out in a fume cupboard. The atmosphere of drying and advantageously of step (c) may also be a pure and dry inert gas such as U-grade nitrogen of purity <99.5% or FID-grade industrial air.

The duration of step (c) of the method according to the present invention depends on the technique and the operating conditions (temperature, pressure, solvent, quantity treated) implemented to carry out this step and is thus variable. Advantageously, this duration is between 1 h and 5 days and notably between 2 h and 2 days and is so done notably for drying under inert gas at room temperature of ten or so grams of sample.

Following the drying step, a precursor of at least one carbide of at least one metal is obtained. The latter is advantageously in the form of a gel in which nanoparticles of oxyhydroxides of MO_{(DO/2-n)}(OH)₂ₙ type, with 0≦n≦DO/2 (with DO=degree of oxidation of the metal element M) of at least one metal are distributed in a homogeneous manner. This precursor is thus a solid precursor, homogeneous at the nanometric scale. The method according to the present invention makes it possible to increase the contact surface between the reagents brought into play during the carboreduction treatment and to increase the homogeneity of the mixture by considerably reducing the size of the MO₂ and C domains within the precursor mixture.

Step (d) of the method according to the present invention consists in transforming the precursor into a carbide of at least one metal by implementation of a thermal treatment. This transformation is carried out under rough vacuum or in an inert atmosphere such as an atmosphere of argon, nitrogen or one of the mixtures thereof.

This step of thermal treatment may comprise the following operations:
an operation of pyrolysis of the precursor obtained following the aforementioned drying step (c) at an efficient temperature and duration to cause the decomposition of said precursor and notably of said gel;
an operation of carboreduction of the pyrolysed precursor obtained at the end of the pyrolysis operation at an efficient temperature and duration to obtain a powder comprising at least one carbide of at least one metal.

The precursor obtained following step (c) undergoes, during pyrolysis, a thermal treatment in an atmosphere devoid of or depleted in oxygen, which results in a degradation of said precursor and, in a concomitant manner, a removal of the volatile compounds thus formed, by which means the resulting material becomes richer and richer in carbon, as the pyrolysis progresses. In addition, this pyrolysis step makes it possible to improve the crystallisation of the metal oxides contained in the precursor.

Thus, once the step of removal of solvent and notably of drying has been completed, the gel is heated under rough vacuum or in an inert atmosphere such as atmosphere of argon, nitrogen or one of the mixtures thereof, at a temperature in the range of around 600° C. to 1200° C. and notably at a temperature of the order of 1000° C. (i.e. 1000° C.±100° C.) to pyrolyse the matrix formed by the organic gelling agent in order to obtain free carbon, while removing the volatile constituents other than the metal/metals and the carbon of the precursor.

The precursor may be taken to the temperature that it has after the step of drying or from room temperature to the pyrolysis temperature defined previously in an increasing manner that is either linear, or with at least one stage. Advantageously, the rate of temperature rise during the pyrolysis step takes place in an increasing linear manner notably with a ramp of 1 to 20° C. per minute, notably a ramp of 2 to 10° C. per minute and, more particularly, a ramp of 3 to 5° C. per minute.

Typically, maintaining the pyrolysis temperature lasts between 1 h and 8 h, notably between 2 h and 6 h and, in particular, of the order of 4 h (i.e. 4 h±30 min).

The pyrolysed precursor obtained at the end of the pyrolysis operation is advantageously in the form of a residue encapsulating the nanoparticles of oxides of at least one metal in a carbon coating, said nanoparticles being distributed in a homogeneous manner in said coating. Advantageously, the nanoparticles contained in this residue have characteristic dimensions between 1 nm and 100 nm, notably between 2 nm and 50 nm and, more precisely, between 3 nm and 30 nm.

During the carboreduction step, the pyrolysed precursor obtained following the pyrolysis step is heated, under rough vacuum or in an inert atmosphere such as an argon atmosphere, to a temperature above 1050° C., notably below 2000° C. and, in particular, below 1700° C. The pyrolysis temperature is typically between 1050° C. and 1700° C., typically between 1050° C. and 1600° C. and notably at a temperature of the order of 1400° C. (i.e. 1400° C.±100° C.) under argon or at a temperature of the order of 1200° C. (i.e. 1200° C.±100° C.) under rough vacuum, to make the metal/metals and carbon react in order to obtain a powder of at least one carbide of at least one metal of high purity.

The pyrolysed precursor may be taken from the temperature that it has after the pyrolysis step or from a temperature below the latter to the carboreduction temperature defined previously in an increasing manner that is either linear, or with at least one stage. Advantageously, the rate of rise in temperature during the carboreduction step takes place in an increasing linear manner notably with a ramp of 1 to 20° C. per minute, notably a ramp of 2 to 10° C. per minute and, more particularly, a ramp of 3 to 5° C. per minute.

Typically, maintaining the carboreduction temperature lasts between 15 min and 8 h, notably between 30 min and 5 h and, in particular, of the order of 3 h (i.e. 3 h±1 h).

The reaction of carboreduction of the precursors obtained following steps (a) to (c) and following the pyrolysis step of the method according to the invention is facilitated thanks to the large reactive surface between the oxide and the carbon. Despite the synthesis transformation, it is possible to conserve the nanometric character of the particles. Also, the powder of at least one carbide of at least one metal obtained following the method according to the present invention is in the form of nanoparticles having characteristic dimensions between 1 nm and 100 nm, notably between 1 nm and 50 nm and, more precisely, between 1 nm and 30 nm.

Typically, the powder of at least one carbide of at least one metal, such as, for example, a powder of uranium carbide, obtained following the method according to the present invention has a specific surface, determined by the BET (for “Brunauer, Emett and Teller”) method between 5 m²/g and 100 m²/g and notably between 10 m²/g and 60 m²/g.

Advantageously, the powder of at least one carbide of at least one metal, such as, for example, a powder of uranium carbide, obtained following the method according to the present invention has a residual oxygen content less than or equal to 0.5% by weight and notably less than or equal to 0.1% by weight.

The method according to the present invention may be implemented to prepare a mixed carbide of two different metals.

In a 1^{st} embodiment and in the case where the two metals are able to form insoluble oxides by hydrolysis in a same pH range, the method for producing a mixed carbide of these two metals is implemented using a solution (Sb) containing an inorganic salt of each of these two metals.

In a 2^{nd} embodiment and notably if the two metals form insoluble oxides by hydrolysis at different pHs, the method for producing a mixed carbide of these two metals consists in:
preparing a 1^{st} colloidal suspension comprising nanoparticles of oxide of a 1^{st} metal according to steps (a) and (b) as defined previously,
preparing a 2^{nd} colloidal suspension comprising nanoparticles of oxide of a 2^{nd} metal, different to said 1^{st} metal according to steps (a) and (b) as defined previously,
mixing the two colloidal suspensions thus prepared, then subjecting them to steps (c) and (d) as defined previously.

Advantageously, the mixing of the two colloidal suspensions may be implemented under a flow of an inert gas and notably under flow of argon, nitrogen or one of the mixtures thereof or ideally in a glove box and is so done notably to avoid oxidation of the colloidal suspensions. This mixing may be carried out under agitation, for example, using an agitator, a magnetic stirrer bar, an ultrasound bath or a homogeniser.

This 2^{nd} embodiment makes it possible to obtain mixed carbides simply while avoiding the problems of degree of oxidation and charge compensation found with co-precipitation methods employed in the prior art.

The present invention also relates to a powder of at least one carbide of at least one metal capable of being prepared according to a method according to the present invention as described previously.

This powder has at least one of the characteristics described (i.e. characteristic dimensions of the nanoparticles forming this powder, specific surfaces of the nanoparticles forming this powder and residual oxygen contents). Advantageously, this powder has at least has two of the aforementioned characteristics such as (i) characteristic dimensions and specific surfaces of the nanoparticles forming this powder, (ii) characteristic dimensions of the nanoparticles forming this powder and residual oxygen contents and (iii) specific surfaces of the nanoparticles forming this powder and residual oxygen contents. More particularly, this powder has the three aforementioned characteristics.

The present invention finally relates to a method for preparation of a dense material of at least one carbide of at least one metal, said method comprising the steps consisting of:
preparing a powder of at least one carbide of at least one metal according to a method of preparation as defined in the present invention; then
subjecting said powder to a sintering step and doing so after optional shaping.

On account of the characteristics of the powders obtained by the method for preparation according to the present invention, it is not necessary to subject the powders thus prepared to a grinding step prior to the sintering step.

Any sintering step known to those skilled in the art can be used within the scope of the present invention. As an illustrative, non-limiting example, this sintering step may be carried out at a temperature and a duration that can range, respectively, from 1600 to 2200° C. and from 5 to 420 minutes, with a rate of rise in temperature that can range from 5 to 1000° C./min, for example, under argon or under rough vacuum.

The dense material of at least one carbide of at least one metal thus prepared may be used for all applications implementing such a material such as, for example, in electronics, as carbide type nuclear fuels or targets, as catalysts or as anti-wear protective coatings or as very hard coatings.

Other characteristics and advantages of the present invention will become clearer to those skilled in the art on reading the examples below, given for illustrative and non-limiting purposes, while referring to the appended figures.

### BRIEF DESCRIPTION OF THE DRAWINGS

FIG. 1 shows a scanning electron microscope (SEM) micrograph of a powder of uranium oxide (UO₂) used for the synthesis of carbide by carboreduction according to a method of the prior art.

FIG. 2 proposes a schematic representation of the synthesis of dense sintered pellets of uranium carbide according to a method of the prior art.

FIG. 3 shows a SEM micrograph of a fragment of precursor mixture of carboreduction implemented in a method of the prior art.

FIG. 4 shows the behaviour during carboreduction treatment of a mixture of powders of uranium oxide and carbon according to a method of the prior art.

FIG. 5 proposes a schematic representation of the synthesis of uranium carbide according to the method of the invention in the presence of methyl cellulose.

FIG. 6 shows the stability domain of the suspensions of nanoparticles of uranium oxide as a function of the methyl cellulose concentration.

FIG. 7 shows a transmission electron microscopy and wet-STEM mode scanning electron microscopy image of the colloidal suspension of nanoparticles of UO₂, 2 H₂O (amorphous) in methyl cellulose solution.

FIG. 8 shows the X-ray diffractogram of the powder obtained after the thermal pyrolysis treatment at 1000° C.

FIG. 9 shows a transmission electron microscopy (TEM) image of the nanoparticles of UO₂ in a carbon coating.

FIG. 10 shows scanning electron microscopy images of a fragment of the sample produced by mixing of powders according to the prior art (R=3; FIGS. 10A and 10C) and of a sample prepared by pyrolysis of a suspension of nanoparticles stabilised by methyl cellulose according to the present invention (R=3.4; FIGS. 10B and 10D) and this, at two enlargements (×10000: FIGS. 10A and 10B and ×1000: FIGS. 10C and 10D).

FIG. 11 shows the carboreduction under vacuum of a mixture of powders according to the prior art (REF R_{C/U}=3) and of a sample obtained by the synthesis route according to the present invention (R_{C/U}=3.4).

FIG. 12 shows the X-ray diffractogram of the sample obtained after carboreduction under vacuum of the precursor mixture according to the present invention (R_{C/U}=3.4).

FIG. 13 shows scanning electron microscopy images in such a way as to compare the morphology of the compounds obtained after carboreduction of the mixture of powders according to the prior art (REF R_{C/U}=3; FIG. 13A) and the precursor mixture according to the present invention (R_{C/U}=4.2; FIG. 13B).

### DETAILED DESCRIPTION OF PARTICULAR EMBODIMENTS

I. Synthesis of Uranium Monocarbide by Carboreduction (Prior Art).

This elaboration route is that which is generally retained for the synthesis of uranium carbides at an industrial scale.

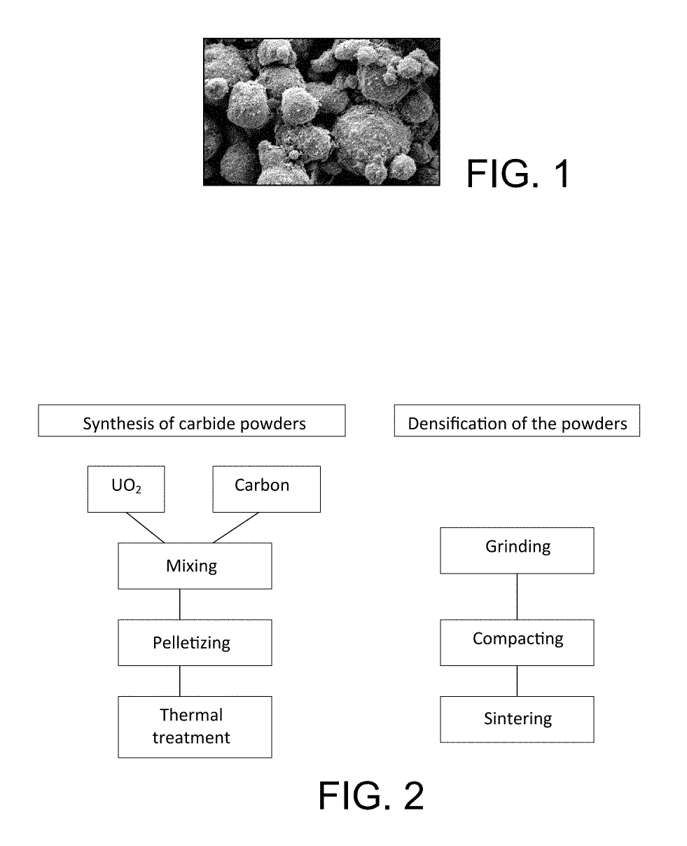

The uranium oxide used may be constituted, for example, of spherical agglomerates the size of which is between 10 μm and 60 μm (FIG. 1).

The carbon used may be, for example, a powder of ground natural graphite constituted of particles having diameters between 10 μm and 110 μm.

With the aim of producing a monophase uranium carbide of overall formula UC, with a molar ratio n_{C}/n_{U}=1, the quantities of uranium and carbon introduced into the mixture have to be precise because the stoichiometry domain is very narrow. These quantities are thus weighed out accurately. The different uranium carbide synthesis steps are shown in FIG. 2.

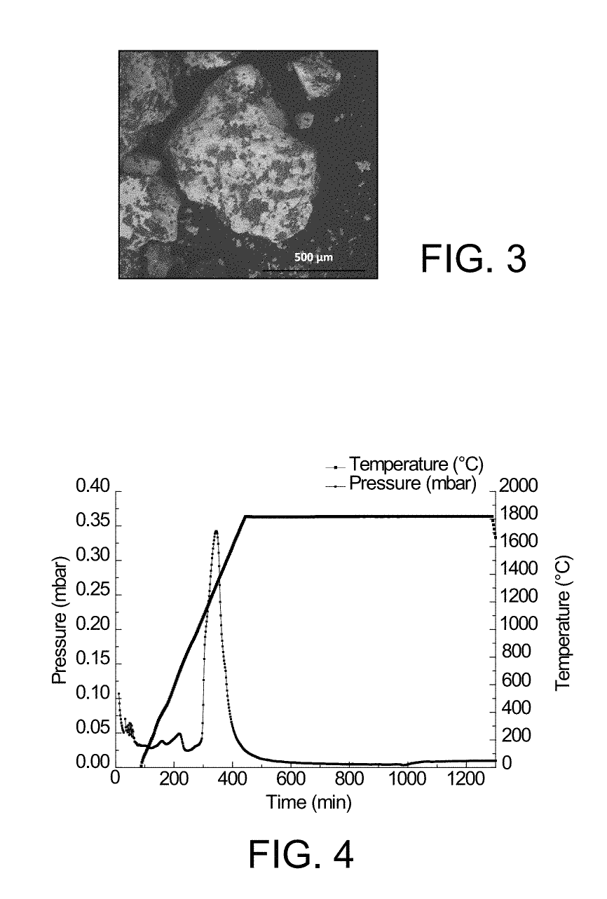

The mixture of powders (oxide+carbon) observed by SEM micrography shows a heterogeneous mixture at the hundreds of micron scale (BSE mode, FIG. 3). The SEM micrograph reveals the heterogeneity of the mixture of precursors obtained by this conventional route. Zones rich in UO₂ (in white) and zones rich in carbon (in black) of several tens to hundreds of microns exist.

A thermal cycle called carboreduction, at a temperature above 1600° C. under rough vacuum is carried out to achieve the synthesis of the carbide. Monitoring the pressure in the furnace makes it possible to identify the synthesis temperatures (FIG. 4). The rise in pressure observed between 300 and 600 min corresponds to gaseous release during the carboreduction reaction. This increase in pressure (around 300 min) occurs at 1300° C., considered as the temperature of start of carboreduction in these conditions.

The powders obtained cannot directly lead to a dense solid by sintering. Steps of grinding and compacting of the powders are necessary before the thermal sintering treatment to lead to dense products.

The synthesis of mixed carbides (U,Pu)C may be carried out in similar conditions by introducing the two types of oxide at the start.

II. Preparation of Nanoparticles of Uranium Oxide According to the Method of the Invention.

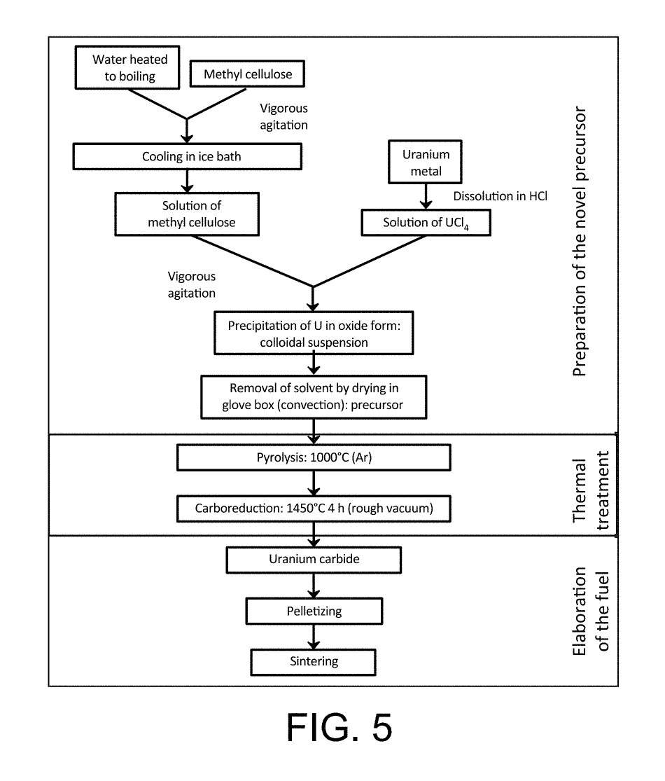

The different steps of the method according to the invention described hereafter are shown schematically in FIG. 5.

II.1. Preparation of the Suspension.

This novel route has been implemented for the synthesis of uranium mono- and dicarbides. The physical properties (specific surface, particle size, oxygen content) of the uranium carbides obtained from this novel synthesis route are improved with a view to the later step of sintering compared to compounds obtained by current methods. The carboreduction temperature is reduced by 200 to 400° C. (under rough vacuum) and the method is simplified regarding the grinding and pelletizing steps compared to the conventional route. This gain will make it possible to reduce both losses in actinides during the carboreduction and the oxygen content of the final product.

A method for preparation of a stable colloidal suspension of nanoparticles has been developed for this novel route. Particular conditions are required to obtain the expected precursor.

The solubility of uranium (IV) (or U(IV)) in basic medium is low (of the order of 2.10⁻¹⁰ mol/L at pH 8). The nanoparticles of precursors of UO₂ are formed by raising the pH of a solution of UCl₄ initially in 7 M HCl. The precipitation of U(IV) in uranium hydroxide form takes place as soon as the pH exceeds 8. Uranium hydroxide is not stable and is transformed in several hours into amorphous dihydrated uranium oxide.

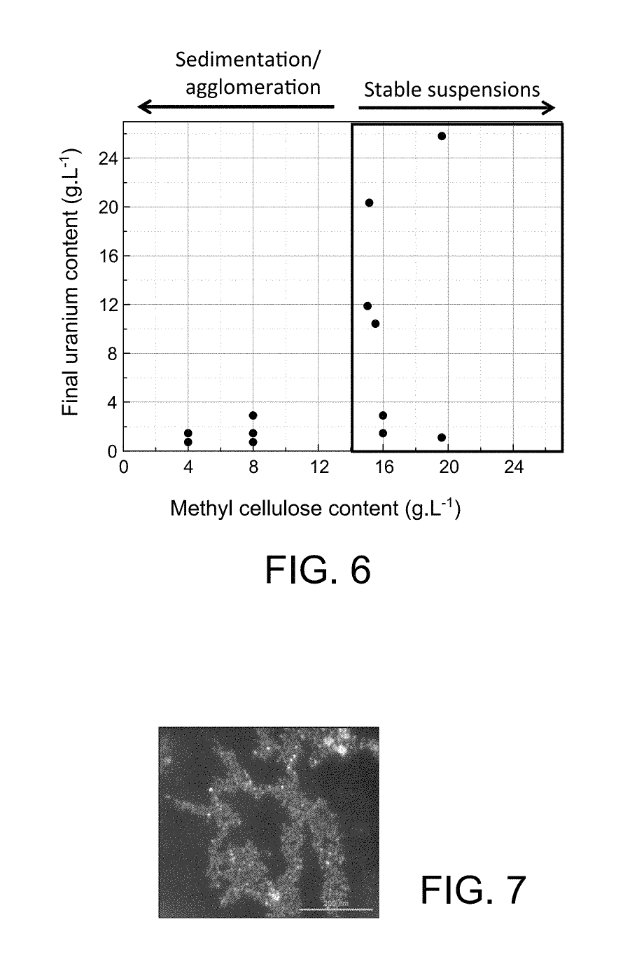

To obtain a stable suspension of nanoparticles, it is necessary to control precipitation and avoid agglomeration of the particles. It is thus necessary to use a water soluble polymer capable both of confining precipitation in the nano-domains and avoiding agglomeration of the nanoparticles. Methyl cellulose has been chosen as stabiliser of the nanoparticles. Adjustment of the methyl cellulose concentration is necessary to stabilise the nanoparticles formed (FIG. 6).

In order to avoid oxidation of the suspensions, it is advisable that the latter are prepared in an inert glove box to avoid oxidation of the uranium dioxide into higher oxides.

From a certain methyl cellulose concentration, the absence of sedimentation for a period of 24 hours is noted. This stability seems practically independent of the uranium content in the solution and thus of the concentration of nanoparticles.

This particular property therefore enables the preparation of suspensions of variable and controllable concentrations of uranium leading to variable ratios R_{C/U} (number of moles of carbon:number of moles of uranium R_{C/U}=n_{C}/n_{U}), in particular, close to the stoichiometry (R_{C/U}=3) to carry out the synthesis of monocarbide according to the following carboreduction reaction:

UO₂+3 C⇄UC+2 CO (gas) (equation 2)

In an identical manner, by changing the ratio R, it is possible to elaborate higher carbides such as a dicarbide.

II.2. Example of Preparation.

For the preparation of suspensions of nanoparticles, a 30 g·L⁻¹ methyl cellulose solution is prepared beforehand. To do so, 100 mL of deionised water are heated to boiling, 3 g of Methocel® (water soluble methyl cellulose, Sigma-Aldrich, CAS No.: 9004-67-5) are added to the boiling water maintained under vigorous agitation for 10 min. The solution is cooled in an ice batch while maintaining agitation. After cooling, the solution is decanted into a 100 mL flask, the volume is made up to 100 mL with deionised water, the missing volume having been lost during boiling and from volume contraction due to the addition of methyl cellulose. The solution is agitated for 24 hours before use.

The pH of the solution is monitored using a pH-meter throughout the experiment. 17 mL of the 30 g·L⁻¹ methyl cellulose solution are introduced into a 50 mL beaker, then 3 mL of a pure ammonia solution (28.0%-30.0%) are added under mechanical agitation using a magnetic stirring bar. The agitation is maintained for 10 min. Using a micropipette, 6 mL of a solution of UCl₄ ([U]=0.47 M in 7 M HCl medium) are collected and added to the solution under agitation. The pH is immediately adjusted to attain a value above 8 using pure ammonia solution (28.0%-30.0%). Stirring is maintained up to stabilisation of the pH at a value above or equal to 8.

FIG. 7 shows the presence of non-agglomerated nanoparticles of several nanometres. The nanoparticles obtained by the proposed synthesis route have a homogeneous size distribution.

II.3. Removal of the Solvent.

The solvent, here water, may be removed by lyophilisation. It may also be removed by evaporation by heating the colloidal suspension to 100° C. or any other means of drying. At this stage, a new precursor mixture is obtained.

II.4. Thermal Pyrolysis Treatment.

Thermal pyrolysis treatment makes it possible to transform the organic molecules into solid amorphous carbon and also makes it possible to improve the crystallisation of UO₂. This treatment may, for example, be carried out with a heating rate of 200° C.·h⁻¹ and an isothermal stage at 1000° C. of 4 hours, under argon with a flow rate of 30 L·h⁻¹. During this step, a strong release of decomposition gas takes place (CO₂, CO, H₂O) and compounds rich in nitrogen and chlorine from the synthesis are also removed.

A control of the pyrolysis conditions, in particular the argon flow rate, is necessary in order to obtain a ratio R_{C/U}=n_{C}/n_{U} reproducible at the end of the treatment.

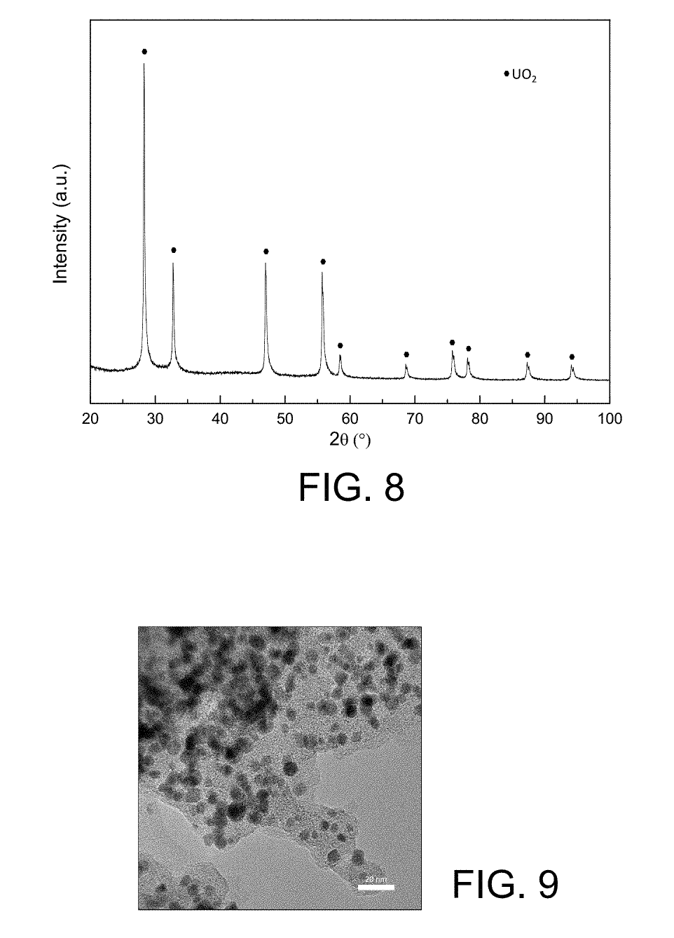

During this thermal treatment, the amorphous uranium oxide becomes crystalline, this phase is the only one identified on the powder X-ray diffractograms (FIG. 8).

After pyrolysis, the morphology of the samples may be observed by transmission electronic microscopy (FIG. 9). The latter shows nanoparticles of UO₂ between 10 and 17 nm diameter, encapsulated in a carbon coating.

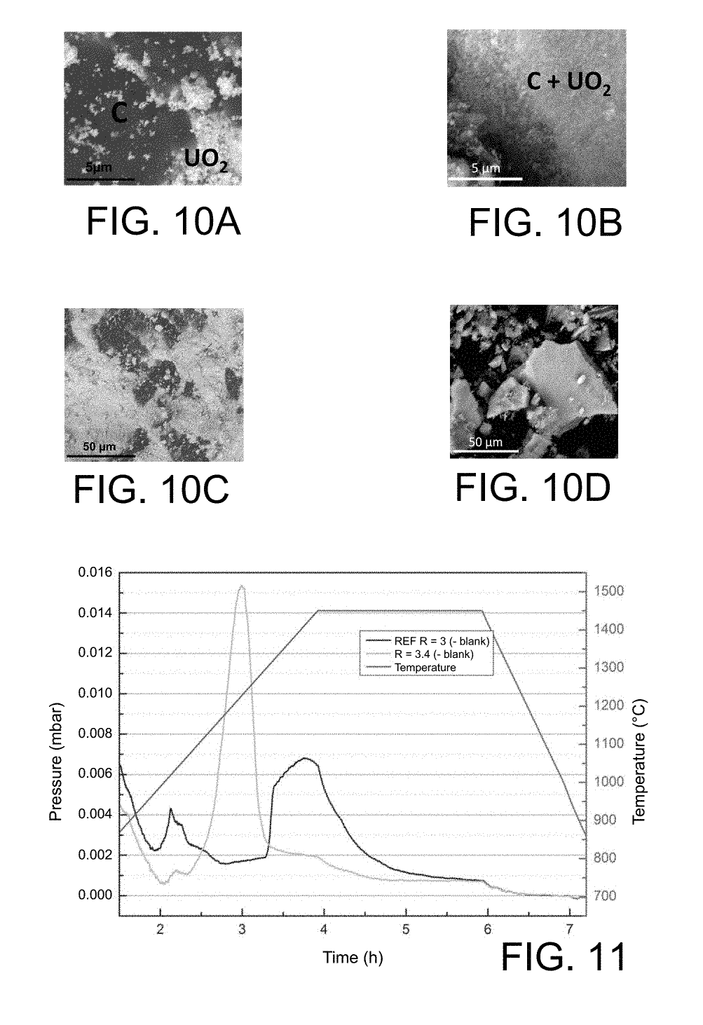

Observations by scanning electron microscopy also make it possible to compare the morphology of samples obtained by this novel route with precursors obtained by the conventional route (FIG. 10).

The homogeneity of the precursor mixture obtained after pyrolysis is very considerably improved compared to the reference sample. For samples prepared from colloidal suspensions, the morphology of the colloidal precursor is conserved after the pyrolysis step and nanoparticles of UO₂ enveloped in a carbon coating are observed.

II.5. Thermal Carboreduction Treatment.

The carboreduction of the precursor is carried out under rough vacuum. In the example that follows, the rate of heating used is 240° C.·h⁻¹, followed by an isothermal stage for 2 hours at 1450° C. The pressure in the furnace is measured using a Pirani gauge, which makes it possible to record with accuracy small pressure variations, notably due to the release of carbon monoxide during carboreduction. A sample obtained by mixing of powders (REF R_{C/U}=3) has undergone the same thermal treatment in order to demonstrate the gain obtained using a new precursor mixture (R_{C/U}=3.4) (FIG. 11).

Under rough vacuum, the lowering of the temperature of start of carboreduction thanks to the use of the novel synthesis route is around 200° C. The difference between the samples is also notable for the end of carboreduction temperature.

The carboreduction of the precursor mixture according to the invention is complete after 1 hour at 1450° C., whereas this temperature maintained for 2 hours does not seem sufficient to complete the carboreduction of the sample obtained by simple mixing of powders. The temperature necessary for the total carboreduction of the reference sample (REF R_{C/U}=3) under rough vacuum is 1750° C. (FIG. 4).

The difference observed between the temperatures of start of carboreduction is explained by the fact that uranium and carbon are intimately mixed at the nanometric scale in the precursor mixture according to the invention. The reaction kinetic increases thanks to the size of the UO₂ domains and their coating in a carbon coating. This reduction in the distances between the reagents accelerates the steps of diffusional transport, which are generally limiting.

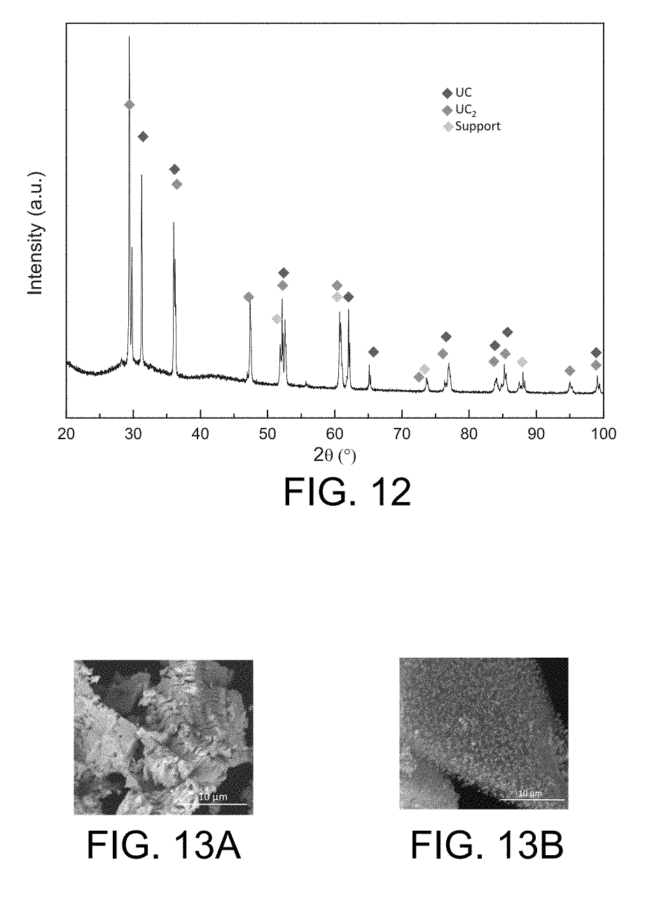

The samples obtained after carboreduction under vacuum have been characterised by powder XRD. The diffractogram of the product obtained by the novel synthesis route after carboreduction is shown in FIG. 12.

The sample derived from carboreduction under vacuum of the precursor according to the present invention (R_{C/U}=3.4) is well crystallised. A mixture of phases is identified as containing 59% by weight of UC and 41% by weight of UC₂ after the Rietveld refinement of the diffractogram shown in FIG. 12. Within the precision boundaries of this analysis, the reaction may be considered as total.

In order to complete the characterisation of the samples after carboreduction, the morphology of the carbides obtained is compared to the conventional route by scanning electron microscopy (FIG. 13).

The morphology of the compounds obtained is extremely different. The sample REF R_{C/U}=3 is in the form of grains of several tens of microns, seemingly homogenous (FIG. 13A). The sample obtained by carboreduction of the precursor mixture according to the invention (R_{C/U}=4.2) is in the form of sub-micrometric grains of carbide (FIG. 13B). The morphology of the carbides depends on the stoichiometry of the samples before carboreduction (ratio R_{C/U}). In the case of the synthesis route proposed in the invention, the residual presence of carbon makes it possible to conserve the carbide in fine particle form. This property is favourable to the later sintering required for the shaping of the fuel.

II.6. Shaping and Sintering.

The carbide powders thus synthesised may then, without any prior step of grinding, be shaped and undergo a conventional sintering cycle.

### REFERENCES

[1] Method to produce a transition metal carbide from a partially reduced transition metal compound, U.S. Pat. No. 5,942,204 A, 1999.
[2] S. Anthonysamy, P. R. Vasudeva Rao, C. K. Mathews, Indira Gandhi Centre for Atomic Research, Carbothermic synthesis of carbides of uranium and plutonium, Kalpakkam, India, Indira Gandhi Centre for Atomic Research, 1986.
[3] D. Vollath, Vorgänge bei der karbothermischen synthese von uran-plutoniumkarbid, J. Nucl. Mater. 64 (1977) 27-36.
[4] D. P. Stinton, S. M. Tiegs, W. J. Lackey, T. B. Lindemer, Rate-Controlling Factors in the Carbothermic Preparation of UO2-UC2-C Microspheres, J. Am. Ceram. Soc. 62 (1979) 596-599.
[5] J. Livage, M. Henry, C. Sanchez, Sol-gel chemistry of transition metal oxides, Prog. Solid State Chem. 18 (1988) 259-341.
[6] X. Deschanels, D. Hérault, G. Arrachart, et al., Comparison of two soft chemistry routes for the synthesis of mesoporous carbon/β-SiC nanocomposites, J. Mater. Sci. 48 (2013) 4097-4108.
[7] R. J. P. Corriu, Ceramics and Nanostructures from Molecular Precursors, Angew. Chem. Int. Ed. 39 (2000) 1376-1398.
[8] C. Sanchez, L. Rozes, F. Ribot, et al., “Chimie douce”: A land of opportunities for the designed construction of functional inorganic and hybrid organic-inorganic nanomaterials, Comptes Rendus Chim. 13 (2010) 3-39.
[9] C. Sanchez, G. J. D. A. Soler-Illia, F. Ribot, D. Grosso, Design of functional nanostructured materials through the use of controlled hybrid organic-inorganic interfaces, Comptes Rendus Chim. 6 (2003) 1131-1151.
[10] H. Preiss, D. Schultze, P. Klobes, Formation of NbC and TaC from gel-derived precursors, J. Eur. Ceram. Soc. 17 (1997) 1423-1435.
[11] M. Dollé, D. Gosset, C. Bogicevic, F. Karolak, D. Simeone, G. Baldinozzi, Synthesis of nanosized zirconium carbide by a sol-gel route, J. Eur. Ceram. Soc. 27 (2007) 2061-2067.
[12] M. El Ghazzal, Elaboration de céramiques par carbo-reduction d'oxydes par des sucres, INP Grenoble, 2010.
[13] P. Colombo, G. Mera, R. Riedel, G. D. Soraru, Polymer-Derived Ceramics: 40 Years of Research and Innovation in Advanced Ceramics, J. Am. Ceram. Soc. 93 (2010) 1805-1837.
[14] D. Sood, The role sol-gel process for nuclear fuels—an overview, J. Sol-Gel Sci. Technol. 59 (2011) 404-416.
[15] V. N. Vaidya, Status of sol-gel process for nuclear fuels, J. Sol-Gel Sci. Technol. 46 (2008) 369-381.
[16] K. Nagarajan, V. N. Vaidya, Sol-Gel Processes for Nuclear Fuel Fabrication, In: M. Aparicio, A. Jitianu, L. C. Klein (Eds.), Sol-Gel Process. Cony. Altern. Energy, Springer US, 2012: pp. 341-373.
[17] G. Cogliati, R. De Leone, E. Mezi, G. Scibona, R. Lanz, Process for Producing Dense Particles of Oxides of Actinides Usable as Fuels for Nuclear Reactors., U.S. Pat. No. 3,401,122, 1968.
[18] R. G. Wymer, Sol-Gel Processes at Oak Ridge National Laboratory: Development, Demonstration, and Irradiation Tests, Oak Ridge National Lab., Tenn. (USA), 1973.
[19] R. G. Wymer, Laboratory and Engineering Studies of Sol-Gel Processes at Oak Ridge National Laboratory., Oak Ridge National Lab., Tenn., 1968.
[20] P. A. Haas, C. C. J. Haws, F. G. Kitts, A. D. Ryon, Engineering Development of Sol-Gel Processes at the Oak Ridge National Laboratory., Oak Ridge National Lab., Tenn., 1968.
[21] IAEA, Proceedings of a panel on sol-gel process for fuel fabrication, Intl Atomic Energy Agency, 1973.
[22] L. \check{C}erović, S. K. Milonji\ddot{c}, S. P. Zec, A comparison of sol-gel derived silicon carbide powders from saccharose and activated carbon, Ceram. Int. 21 (1995) 271-276.
[23] Y. Gotoh, K. Fujimura, M. Koike, et al., Synthesis of titanium carbide from a composite of TiO2 nanoparticles/methyl cellulose by carbothermal reduction, Mater. Res. Bull. 36 (2001) 2263-2275.
[24] Process for preparing fine grain titanium carbide powder, U.S. Pat. No. 4,622,215A/FR2578827, 1986.
[25] Titanium carbide powder and titanium carbide-ceramics composite powder and method for production thereof, and sintered compact from the titanium carbide powder and sintered compact from the titanium carbide/ceramics composite powders and method for production thereof, U.S. Pat. No. 7,915,187 B2, 2011.
[26] Fine metal carbide particles and methods of manufacturing the same, U.S. Pat. No. 8,486,529 B2, 2013.
[27] A. D. Adamczak, A. A. Spriggs, D. M. Fitch, M. Radovic, J. C. Grunlan, Low-Temperature Formation of Ultra-High-Temperature Transition Metal Carbides from Salt-Polymer Precursors, J. Am. Ceram. Soc. 93 (2010) 2222-2228.

1. A method for preparation of a powder comprising at least one carbide of at least one metal comprising the steps consisting of:
a) preparing a solution comprising at least one organic gelling agent and at least one inorganic salt of at least one metal in a solvent;
b) modifying the pH of the solution prepared in step (a) in such a way as to precipitate said at least one metal and to obtain a colloidal suspension comprising nanoparticles of oxyhydroxides of said at least one metal;
c) removing the solvent from the colloidal suspension obtained in step (b) to obtain a precursor of at least one carbide of at least one metal; and
d) subjecting the precursor obtained in step (c) to a thermal treatment in order to transform same into a powder comprising at least one carbide of at least one metal,
said at least one organic gelling agent being the only carbon source used for the production of carbide.

2. The method according to claim 1, wherein said organic gelling agent is selected from the group consisting of a polyvinyl alcohol constituted of the repetition of the —CH₂—CH(OH)— monomer unit, a polymer of acrylic acid constituted of the repetition of the —CH₂—CH(CO₂H)— monomer unit, a copolymer of acrylic acid-acrylamide comprising —CH₂—CH(CO₂H)— and —CH₂—CH(CONH₂)— monomer units, and a polyvinylpyrrolidone constituted of the repetition of the —CH₂—CH(NCOC₃H₆)— monomer unit.

3. The method according to claim 1, wherein said organic gelling agent is selected from the group consisting of methyl cellulose, hydroxyl ethyl methyl cellulose, hydroxyl ethyl cellulose, carboxy methyl cellulose, hydroxyl propyl methyl cellulose, starch, methyl starch, hydroxyl ethyl methyl starch, hydroxyl ethyl starch, carboxy methyl starch, hydroxyl propyl methyl starch, carrageenan, alginate, furcellaran, agar-agar, glucomannan, galactomannan, xanthan gum, fenugreek gum, guar gum, tara gum, carob gum, cassia gum and gellan gum.

4. The method according to claim 1, wherein said metal is selected from the group consisting of cerium, titanium, zirconium, hafnium, thorium, uranium, neptunium, plutonium, americium and curium.

5. The method according to claim 1, wherein said inorganic salt of at least one metal is in the form of a halide of at least one metal or of a nitrate of at least one metal.

6. The method according to claim 1, wherein the solvent of the solution comprising at least one organic gelling agent and at least one inorganic salt of at least one metal is selected from the group consisting of water, deionised water, distilled water, hydroxylated solvents low molecular weight liquid glycols, dimethyl sulfoxide (DMSO), dimethyl formamide (DMF), acetonitrile, acetone, tetrahydrofuran (THF) and one of the mixtures thereof.

7. The method according to claim 1, wherein the removal of the solvent during said step (c) is carried out by at least one technique selected from the group consisting of decantation, air drying, vacuum drying, microwave drying, high frequency drying, sublimation, lyophilisation and any combination thereof.

8. The method according to claim 1, wherein said step of thermal treatment (d) comprises the following operations:
an operation of pyrolysis of the precursor obtained following step (c) carried out at a temperature between 600° C. and 1200° C. maintained for a duration between 1 h and 8 h whereby said precursor decomposes;
an operation of carboreduction of the pyrolysed precursor obtained at the end of the pyrolysis operation carried out at a temperature above 1050° C. maintained for a duration between 15 min and 8 h whereby a powder comprising at least one carbide of at least one metal is obtained.

9. The method according to claim 8, wherein said pyrolysis operation is carried out at a temperature of 1000° C.±100° C.

10. The method according to claim 8, wherein said carboreduction operation is carried out at a temperature between 1050° C. and 1700° C. under argon or at a temperature of 1200° C.±100° C. under rough vacuum.

11. The method according to claim 1, comprising the steps consisting of:
preparing a 1^{st} colloidal suspension comprising nanoparticles of oxyhydroxides of a 1^{st} metal according to steps (a) and (b),
preparing a 2^{nd} colloidal suspension comprising nanoparticles of oxyhydroxides of a 2^{nd} metal, different to said 1^{st} metal according to steps (a) and (b) as defined in claim 1,
mixing the two colloidal suspensions thus prepared, then subjecting them to steps (c) and (d),
to obtain a mixed carbide of these two metals.

12. A powder of at least one carbide of at least one metal capable of being prepared according to a method as defined in claim 1.

13. A method for preparation of a dense material of at least one carbide of at least one metal, said method comprising the steps consisting of:
preparing a powder of at least one carbide of at least one metal according to a method as defined in claim 1, then
subjecting said powder to a sintering step.

14. The method according to claim 6, wherein the solvent is methanol, ethanol or isopropanol.

15. The method according to claim 6, wherein the solvent is ethylene glycol.

16. The method according to claim 10, where the carboreduction operation is carried out at a temperature of 1400° C. under argon.

17. The method according to claim 9, wherein said carboreduction operation is carried out at a temperature between 1050° C. and 1700° C. under argon or at a temperature of 1200° C.±100° C. under rough vacuum.
